(19) United States
(12) Patent Application Publication
(10) Pub. No.: US 2019/0226510 A1
(43) Pub. Date: Jul. 25, 2019

(54) SEMI-FINISHED PRODUCT HAVING FUNCTIONAL ELEMENTS FOR COMPONENTS, COMPONENT MADE FROM SAID SEMI-FINISHED PRODUCT, AND METHOD FOR THE COMPONENT PRODUCTION

(71) Applicants: ThyssenKrupp Steel Europe AG, Duisburg (DE); ThyssenKrupp AG, Essen (DE)

(72) Inventors: Andreas Cott, Düsseldorf (DE); Thomas Flaskamp, Duisburg (DE); Philipp Grunden, Duisburg (DE); Manuel Grundmann, Duisburg (DE); Stefan Mayer, Schwerte (DE); Lothar Patberg, Moers (DE)

(21) Appl. No.: 16/332,071

(22) PCT Filed: Sep. 22, 2017
(86) PCT No.: PCT/EP2017/074046

§ 371 Date: Mar. 11, 2019

(30) Foreign Application Priority Data
Sep. 27, 2016 (DE) 10 2016 218 596.9

(51) Int. Cl. F16B 5/06; B21D 11/08

(52) U.S. Cl. CPC F16B 5/0614; B32B 15/04; B21D 11/08

(57) ABSTRACT

The invention relates to a semi-finished product for producing a three-dimensional component having a metallic base plate which has at least one predefined bending line, characterized in that functional elements are provided on the base plate in the region of a bending line, on both sides of the bending line, said functional elements making contact with one another when the base plate is reshaped along the bending line and permitting a connection. This invention further relates to a method for producing three-dimensional components from said semi-finished product and to said component

### BACKGROUND

The disclosure relates to a semi-finished product for producing three-dimensional components, which are produced from a flat starting material by one or multiple bending processes. The disclosure also includes the method for producing such components and the components.

The production of components, such as profiles, containers for housings or units and the like from precut metal sheets, which are folded accordingly, are known in the prior art.

A current trend is directed toward industrial applications of folding techniques on metal sheets such as, for example, also described in the article “Origami in der Umformtechnik: Bleche falten” [Origami in shaping technology: folding metal sheets] of Aug. 30, 2016 published online (http://www.blechnet.com/origami-in-der umformtechnik-bleche-falten-a-547517/).

DE 10 2008 007 239 A1, DE 19 24 539 A and DE 10 2013 109 616 A1 are also known from the prior art.

### BRIEF DESCRIPTION

The object of the present disclosure is to simplify the shaping of folded components and to ensure dimensionally stable components.

The object is achieved by a semi-finished product according to one aspect of the subject disclosure, by a method for shaping the semi-finished product and by a component produced therefrom.

For a semi-finished product according to one aspect of the subject disclosure, a metal base plate is used for producing a three-dimensional component, which includes at least one predefined bending line, characterized in that functional elements are provided on the base plate in the region of a bending line, on both sides of the bending line, said functional elements making contact with one another when the base plate is reshaped along the bending line and permitting a connection.

This has the advantages that because the functional elements are provided on both sides of the bending line, the semi-finished product is reinforced in this region, as a result of which the reshaping along the predefined bending line is simplified. Appropriately thin metal sheets as base plates or a corresponding pretreatment of the bending line potentially makes reshaping by hand possible, i.e., without the use of machines. The bending line in this case need not necessarily extend in a straight line, but rather bending lines having a curved profile are also possible depending on the shape to be produced. Multiple bending lines are, of course, also possible, which may extend independently of one another, may meet and/or also may intersect depending on the shape to be produced.

A further advantage is that the degree of reshaping along the bending line may be predefined by the functional elements, since mechanical limitations, such as the limit stop of the functional elements against one another and/or against a region on the base plate opposite the bending line may occur as a result of the design of the functional elements. This also favors a reshaping without tools or with simple tools. The shape and/or size of the functional elements along the bending line is/are preferably the same. The functional elements along the bending line may have a continuous or abruptly changing cross sectional profile, in particular, in the case of curved or intersecting bending lines. Sub-regions without functional elements may also be provided along the bending line.

It is also provided according to one aspect of the present disclosure that the functional elements include latching elements, which latch to one another and thus produce a form-fitting connection. The design, in which, for example, a functional element has a hook and an opposing functional element relative to the bending line has a corresponding catch, ensures that the reshaping encompasses a minimum angle and that this angle is maintained due to the form-fitting connection. This also prevents a potential spring back of the reshaped base plate due to resilient parts of the deformation. This has the advantage that dimensionally stable components may be produced without the need for additional tools.

A semi-finished product according to this or another aspect may alternatively or also be characterized in that the functional elements have surfaces and/or recesses for accommodating connection means.

A connection means includes a variety of different designs, thus, for example, the functional elements may be identically designed on both sides of the bending line and the connection means may correspondingly symmetrically include corresponding counterparts one on each side, for example, for a latch connection. This has the advantage that the functional elements may be identically shaped. With differently designed connection means, for example, different widths or varying distance of the functional elements from the bending line, it is possible to variously adjust the bending angle accordingly.

Other examples of connection elements include locking elements, such as pins, clamps screws and the like, which connect the functional elements to one another after reshaping, preferably in a form-fitting manner, alternatively or in addition, also in a force-locking manner. Possible designs include functional elements, for example, which mesh in a comb-like fashion and include recesses or gaps largely parallel to the bending line, which align with one another and into which the locking elements are introduced.

Alternatively or in addition, surfaces of the functional elements that come into contact with one another may be provided as a connection means for producing a preferably materially bonded connection using an adhesive as the connection means.

In the semi-finished product according to an aspect of the subject disclosure, the base plate is also at least partially coated on the side of the functional elements with a plastic layer and the plastic layer is situated at least between the base plate and the functional elements. In other words, the base plate is provided with a plastic layer as a coupling layer at least in the region of the functional elements. The advantage of plastic-coated base plates is in the optionally simplified connection of, for example, functional elements manufactured from plastic by injection molding, by adhesion or by welding.

In another exemplary embodiment of the semi-finished product, the plastic layer extends over the entire surface of the base plate. This simplifies the production of the starting material for the base plate, since the starting material may be coated regardless of the optionally trimmed shape and of the position of the base plate.

Examples for the design of the plastic layer as a coupling layer are described, for example, in the unexamined patent application DE 10 2013 109 616 A1, wherein the paragraphs [0008], [0009], [0011], [0012], [0014], [0015] and [0017] of this unexamined patent application are incorporated herewith as part of the description.

In other embodiments, a semi-finished product according to the one aspect is characterized in that the functional elements are designed as a form element, which are connected with a flexible section extending across the bending line. To correctly position the functional elements on the base plate, it is advantageous if the functional elements include a section, which interconnects them to form a form element. This form element may be correspondingly aligned on the bending line, for which aids, such as gaps or positioning aids may optionally be provided in the connecting section. Since at least portions of the sections are located above the bending line and thus must also be deformed during reshaping, the sections are designed to be maximally flexible and are not connected to the base plate, at least in the region of the bending line, in order to hold the additional expenditure of force to a minimum.

In other embodiments of a semi-finished product, the functional elements are made of plastic. As a result, it may be relatively easy to produce complex forms or cross sectional profiles of the functional elements by injection molding or by extrusion. In addition, the connection to any potential plastic coupling layer is simplified since, in addition to adhesive bonding, methods such as welding, for example, ultrasonic welding or spraying, are also enabled. Plastics also offer a cost and weight advantage. Alternatively, the functional elements may also be manufactured from another material. Metal materials would be possible, such as die-cast aluminum, or regenerative materials, such as wood, as well as composite materials from combinations of the various aforementioned materials. This material selection is, of course, also available for any connection means or locking elements.

Other embodiments of the semi-finished product are characterized in that the base plate is pre-embossed, notched and/or perforated along the bending line. The required shaping force can be reduced and the position of the subsequent bending edge predetermined, in particular, when reshaping without tools or with only simple tools, through appropriate pre-shaping, material thinning and/or material weakening along portions of the bending line.

A semi-finished product according to one aspect is characterized in other embodiments in that stiffening elements are at least partially mounted on the base plate. For semi-finished products or components having large surface areas, in particular, it is advantageous for stiffening elements to be provided on the base plate of the semi-finished product. These may be designed, for example, as ribs or as a lattice structure.

A semi-finished product according to this or another aspect is further characterized in that the base plate is monolithic or is formed by a multilayer composite having at least one metallic layer. The base plate may therefore be made of a metal plate, in particular, a steel plate, particularly preferably, a steel plate having a protective layer against corrosion, or of a multilayer composite material. Monolithic materials are generally more advantageous, whereas composite materials may allow for a reduction in weight.

Another aspect of the subject disclosure provides a method for producing a three-dimensional component made of a semi-finished product, wherein the base plate of the semi-finished product is bent along the bending line, and the method is characterized in that the functional elements are brought into contact during reshaping, and that a form-fitting, force-locking and/or materially bond connection is produced between the functional elements by latching elements and/or by connection means.

Other embodiments of the method can be characterized in that after reshaping, at least one locking element is introduced into the functional elements as a connection means for producing a form-fitting connection.

Embodiments of the method can be additional or alternatively characterized in that prior to reshaping, an adhesive is applied as a connection means to the contacting surfaces of the functional elements.

Additional components can be the use of a semi-finished product according to the subject disclosure for producing a three-dimensional component, as well as a component, which is characterized in that the component includes a reshaped semi-finished product, in which functional elements are connected to one another.

### BRIEF DESCRIPTION OF THE DRAWINGS

Additional details and features of the subject disclosure emerge from the drawings and from the following description with reference to the schematic illustrations not to scale.

The figures represent merely schematic exemplary embodiments. Identical parts are identified by identical reference numerals.

FIG. 1 shows an embodiment of a semi-finished product according to one aspect.

FIG. 2 shows an embodiment of a semi-finished product according to the product of FIG. 1 after reshaping.

FIG. 3 shows another embodiment of a semi-finished product,

FIG. 4 shows another embodiment of a semi-finished product after reshaping,

FIG. 5 shows another embodiment of a semi-finished product, and

FIG. 6 shows an embodiment of a connection means for the semi-finished product of FIG. 5.

### DETAILED DESCRIPTION

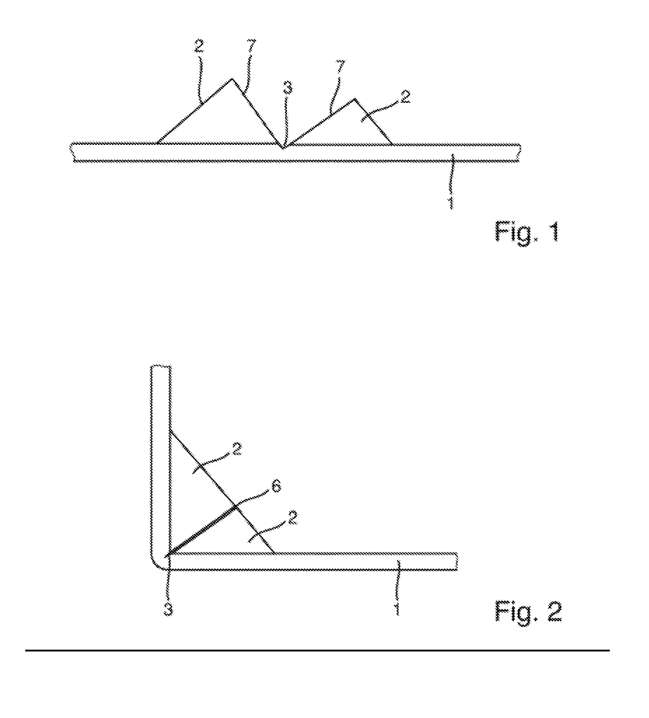

The example of a design of the semi-finished product according to an exemplary embodiment shown in FIG. 1 shows a base plate 1, in this example having a monolithic design, which includes a bending line 3. The bending line in this embodiment is depicted as notched by way of example. This notch defines the bending line 3 and a subsequent reshaping is facilitated. The weakening of the base plate 3 by the notch along the bending line 3 is less critical, since this region is reinforced in the finished component by the connection of the functional elements 2. The functional elements 2 are provided on base plate 1 on both sides of the bending line 3. In this example, the functional elements 2 are designed identically having a triangular cross section, wherein the surface 7 situated on the side of the bending line 3 is provided as a surface for accommodating a connection means 6. Other cross sectional shapes may, of course, also be used, and differently shaped functional elements 2 may be provided on the various sides of the bending line 3.

FIG. 2 shows a region of a component made of a semi-finished product in the manner of FIG. 1, wherein the base plate 1 has been reshaped along the bending line 3. As a result, the functional elements 2 situated on both sides of the bending line 3 with their surfaces 7 provided for accommodating connection means 6 have been brought into contact. In this illustration, an adhesive has been introduced as a connection means 6 between the surfaces 7 of the functional elements 2. The connection means 6 for this embodiment is applied, for example as an adhesive or also as a double-sided adhesive tape, however, the use of a connection means 6 in the form of a Velcro fastener for a reversible connection is also possible. Dual-component adhesives, in particular, are suitable as an adhesive, preferably those, which may be applied separately to the contacting surface 7 and which initiate a curing action only upon contact with the opposite side.

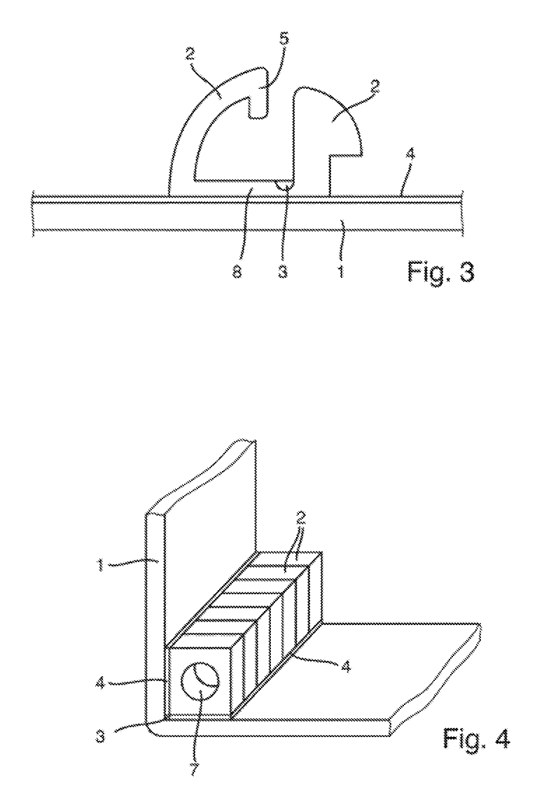

The region of a semi-finished product depicted in FIG. 3 includes a base plate 1, the entire surface of which is coated with a plastic layer 4. The advantage of a plastic layer 4 is that functional elements 2 manufactured from plastic, for example, are more easily connectable to this plastic layer 4, for example, via adhesive bonds or welds. The functional elements 2 in the embodiment depicted are connected to one another by a section 8, which extends across the bending line 3. The advantage of such a design as a form element is that the functional elements 2 may be produced in one step such as, for example, by means of injection molding, and at the same time the positioning of the functional elements 2 relative to one another is established, facilitating their correct positioning when attaching them to the base plate 1 or to the plastic layer 4. The functional elements 2 in this exemplary embodiment are differently shaped in order to enable a latch connection. In the example depicted, the left functional element 2 includes a latching element 5, which slides over the outer circumference of the right functional element 2 up to an edge during reshaping and subsequently forms a form-fitting, reversible connection with a shoulder on the right functional element 2. The functional elements in this case may have a width that extends over the entire length of the bending line 3 or also only over subsections thereof.

The exemplary embodiment depicted in FIG. 4 shows a reshaped semi-finished product, in which the base plate 1 is reshaped along the bending line 3. The base plate 1 is coated with a plastic layer 4 only in the regions adjacent to the bending line 3. The functional elements 2 in this case are situated offset along the bending line 3 and not opposite one another, as in the previous exemplary embodiments, as a result of which the functional elements 2 mesh in a comb-like manner during reshaping. The functional elements 2, because of their offset arrangement, are situated one behind the other in a reshaped semi-finished product, as viewed in the direction of the bending line 3. Recesses 7 provided in the functional elements 2 are aligned as a result of the reshaping, i.e., oriented relative to one another in such a way that a connection means not depicted may be introduced as a locking element, for example, in the form of a pin, splints or a screw, into the recesses 7. This results in a form-fitting connection between the functional elements 2. Adhesives may also be applied as additional connection means in such embodiments on surfaces, which are provided for contacting with functional elements 2 situated offset relative to one another and/or to the opposing base plate 1. In addition to the depicted round cross section, the recesses 7 may also have different arbitrary closed cross section or also an open cross section.

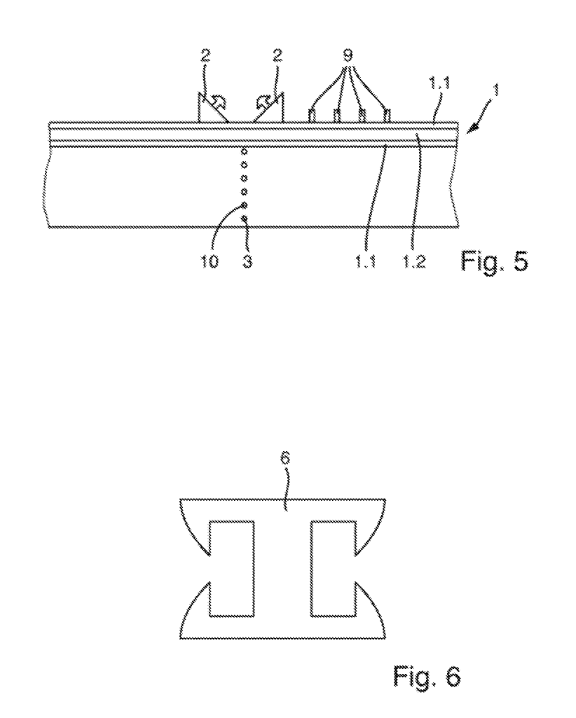

FIG. 5 shows another embodiment of a semi-finished product from a perspective view, wherein the base plate 1 is designed as a composite material having at least one metallic layer 1.1. In the example depicted, the base plate 1 is made of a sandwich material consisting of two outer lying metallic layers 1.1 and a core layer 1.2 sandwiched in between. The base plate 1 is provided with perforations 10 along the bending line 3. The base plate 1 is weakened by the perforations 10 along the bending line 3, which reduces the expenditure of force necessary for reshaping and which defines the bending line. Functional elements 2 are situated on both sides of the bending line 3. In this exemplary embodiment, the functional elements 2 are identically designed and have T-shaped projections, each of which may serve as counterparts for latch hooks of a latch connection or as surfaces for accommodating profiles. In this exemplary embodiment, the connection between the functional elements 2 is achieved by a separate connection means 6. Also indicated in FIG. 5 are stiffening elements 9 in the form of ribs, which facilitate a stiffening of the base plate 1 in regions deviating from the bending line 3. These stiffening elements 9 may, of course, also be provided on both sides of the bending line 3 and/or may be connected to the functional elements 2.

The size, shape, orientation and number of stiffening elements 9 may also be adapted to the respective needs.

An embodiment of a connection element 6 is depicted in FIG. 6 for a design according to FIG. 5. This connection element 6 is symmetrically designed and includes latch hooks and recesses on both sides, which may produce a form-fitting connection with the T-shaped projections depicted in FIG. 5.

It will be appreciated that various implementations of the above-disclosed and other features and functions, or alternatives or varieties thereof, can be desirably combined into many other different systems or applications. Also that various presently unforeseen or unanticipated alternatives, modifications, variations or improvements therein can be subsequently made by those skilled in the art which are also intended to be encompassed herein.

1. A semi-finished product for producing a three-dimensional component having a metallic base plate, which has at least one predefined bending line, wherein the metallic base plate is monolithic or is formed by a multilayer composite having at least one metallic layer, and wherein functional elements, which make contact with another when the base plate is reshaped along the bending line and which facilitate a connection, are provided on the base plate in the region of the bending line on both sides of the bending line, and wherein the functional elements include latching elements, which latch to one another during reshaping along the bending line and thus produce a form-fitting connection and/or the functional elements include latching elements, surfaces and/or recesses for accommodating connection means, and that the base plate on the side of the functional elements is coated at least partially with a plastic layer, and that the plastic layer is situated at least between the base plate and the functional elements.

2. The semi-finished product according to claim 1, wherein the plastic layer extends over the entire surface of the base plate.

3. The semi-finished product according to claim 1, wherein the functional elements are designed as a form element, which are connected with a flexible section extending across the bending line.

4. The semi-finished product according to claim 1, wherein the functional elements are made of a plastic.

5. The semi-finished product according to claim 1, wherein the base plate is pre-embossed, notched and/or perforated along the bending line.

6. The semi-finished product according to claim 1, wherein stiffening elements are mounted at least partially on the base plate.

7. A method for producing a three-dimensional component from a semi-finished product wherein the semi-finished product has a metallic base plate, which has at least one predefined bending line, wherein the metallic base plate is monolithic or is formed by a multilayer composite having at least one metallic layer, and wherein functional elements, which make contact with another when the base plate is reshaped along the bending line and which facilitate a connection, are provided on the base plate in the region of the bending line on both sides of the bending line, and wherein the functional elements include latching elements, which latch to one another during reshaping along the bending line and thus produce a form-fitting connection and/or the functional elements include latching elements, surfaces and/or recesses for accommodating connection means, and that the base plate on the side of the functional elements is coated at least partially with a plastic layer, and that the plastic layer is situated at least between the base plate and the functional elements, wherein the base plate of the semi-finished product is bent along the bending line, wherein the functional elements are brought into contact as a result of the reshaping, and that a form-fitting, force-locking and/or materially-bonding connection is produced between the functional elements by latching elements and/or connection means.

8. The method according to claim 7, wherein after the reshaping, at least one locking element is introduced as a connection means into the functional elements to produce a form-fitting connection.

9. The method according to claim 7, wherein prior to the reshaping, an adhesive is applied as a connection means to the contacting surfaces of the functional elements.

10. A use of a semi-finished product according to claim 1 for producing a three-dimensional component.

11. A component, wherein the component includes a reshaped semi-finished product according to claim 1, in which functional elements are connected to one another.
